(19) United States
(12) Patent Application Publication
(10) Pub. No.: US 2025/0251046 A1
(43) Pub. Date: Aug. 7, 2025

(54) BALL VALVE WITH ANTISTATIC FUNCTION

(71) Applicant: K2N CO., LTD., Wonju-si (KR)

(72) Inventors: Dong Yoel KIM, Wonju-si (KR); Tae Hun PARK, Wonju-si (KR)

(73) Assignee: K2N CO., LTD., Wonju-si (KR)

(21) Appl. No.: 19/043,028

(22) Filed: Jan. 31, 2025

(30) Foreign Application Priority Data
Feb. 2, 2024 (KR) 10-2024-0016518

(51) Int. Cl. F16K 5/06; F16K 25/00

(52) U.S. Cl. CPC F16K 5/0689; F16K 25/005

(57) ABSTRACT

The present disclosure provides a ball valve with an antistatic function, the ball valve including a cap unit and a body unit coupled to each other to provide a flow passage of a fluid; a ball unit provided on the flow passage of the fluid to control a flow of the fluid by rotation; a handle unit providing an external force for the rotation of the ball unit; a stem unit connecting the ball unit and the handle unit to transmit the external force provided by the handle unit to the ball unit; a first lined unit provided on an inner surface of the cap unit to prevent the cap unit from coming into contact with the fluid and prevent oxidation of the cap unit due to the fluid.

### CROSS-REFERENCE TO RELATED APPLICATION

This application claims priority to and the benefit of Korean Patent Application No. 10-2024-0016518, filed on Feb. 2, 2024, the disclosure of which is incorporated herein by reference in its entirety.

### BACKGROUND

### 1. Field of the Invention

The present disclosure relates to a ball valve with an antistatic function, and more particularly, to a ball valve with an antistatic function that enables grounding of static electricity generated during the flow of a fluid, thereby preventing a risk of explosion due to sparks or the like.

### 2. Discussion of Related Art

A ball valve is one of the valves used to control the flow of fluid and is a valve that uses a rotatable spherical ball to adjust the amount of fluid passing therethrough.

The spherical ball has a hole formed in the center, and the position and size of the hole are adjusted as the spherical ball rotates through a rotatable shaft.

When the hole formed in the spherical ball is in a straight line with a flow path, the flow path reaches a state in which it is completely open, and when the hole is perpendicular to the flow path, the flow path reaches a state in which it is completely closed.

The ball valve described above is used to control the flow of various liquid chemicals required in the manufacturing process of semiconductors, displays, etc.

Here, a chemical called diluted hydrofluoric acid is used in the process of cleaning, etching, etc., of semiconductor substrates, and the chemical has characteristics of high purity and high toxicity.

Meanwhile, static electricity may be generated due to friction during the flow of chemicals, and this static electricity may cause sparks and lead to unexpected problems such as explosion.

In order to address problems due to static electricity, in the related art, as disclosed in Korean Unexamined Patent Application Publication No. 10-2010-0090944, a spring is placed at a connection portion between a stem and a ball, and an effect of preventing static electricity by the spring is expected. However, the spring causes a problem that a fastening force between the stem and the ball is reduced due to the spring and also a problem that it is difficult to maintain purity due to oxidation or the like.

Therefore, there is an urgent need for research on a ball valve that can, while maintaining purity of a chemical, prevent the possibility of explosion due to static electricity.

### SUMMARY OF THE INVENTION

The present disclosure is directed to providing a ball valve with an antistatic function that enables grounding of static electricity generated due to friction with a fluid while preventing generation of impurities due to oxidation to maintain purity of a flowing fluid, thereby preventing a risk of explosion due to sparks or the like.

According to an aspect of the present disclosure, there is provided a ball valve with an antistatic function, the ball valve including a cap unit and a body unit coupled to each other to provide a flow passage of a fluid; a ball unit provided on the flow passage of the fluid to control a flow of the fluid by rotation; a handle unit providing an external force for the rotation of the ball unit; a stem unit connecting the ball unit and the handle unit to transmit the external force provided by the handle unit to the ball unit; a first lined unit provided on an inner surface of the cap unit to prevent the cap unit from coming into contact with the fluid and prevent oxidation of the cap unit due to the fluid; and a second lined unit provided on an inner surface of the body unit to prevent the body unit from coming into contact with the fluid and prevent oxidation of the body unit due to the fluid, wherein the first lined unit and the second lined unit are made of fluororesin to reduce generation of static electricity due to friction with the fluid, and the ball unit and the stem unit are made of metal for grounding of the static electricity generated in the flow passage.

The ball valve according to the present disclosure may further include a grounding line unit connected to the stem unit to make the grounding possible.

The ball valve according to the present disclosure may further include a seat ring unit provided between the ball unit and the first lined unit to prevent the fluid from flowing toward the stem unit in a case in which the fluid passes through a fluid hole of the ball unit, wherein the seat ring unit provides a space due to non-contact between surfaces in contact with the ball unit to allow the fluid to reside in the space even when the fluid permeates through one of the surfaces.

### BRIEF DESCRIPTION OF THE DRAWINGS

The above and other objects, features, and advantages of the present disclosure will become more apparent to those of ordinary skill in the art by describing exemplary embodiments thereof in detail with reference to the accompanying drawings, in which:

FIG. 1 is a coupling perspective view illustrating a ball valve with an antistatic function according to the present disclosure;

FIG. 2 is an exploded perspective view illustrating the ball valve with an antistatic function according to the present disclosure; and

FIG. 3 is a cross-sectional view illustrating a ball valve with an antistatic function according to the present disclosure;

### DETAILED DESCRIPTION OF EXEMPLARY EMBODIMENTS

Hereinafter, specific embodiments of the present disclosure will be described in detail with reference to the accompanying drawings. However, the spirit of the present disclosure is not limited by the embodiments presented herein, and those of ordinary skill in the art who understand the spirit of the present disclosure may easily propose other less advanced inventions or other embodiments belonging to the scope of the spirit of the present disclosure by adding another component, changing a component, or omitting a component within the scope of the same spirit, but such inventions or embodiments also pertain to the scope of the spirit of the present disclosure.

In addition, components with the same function within the scope of the same spirit shown in the drawings of different embodiments will be described using the same reference numerals.

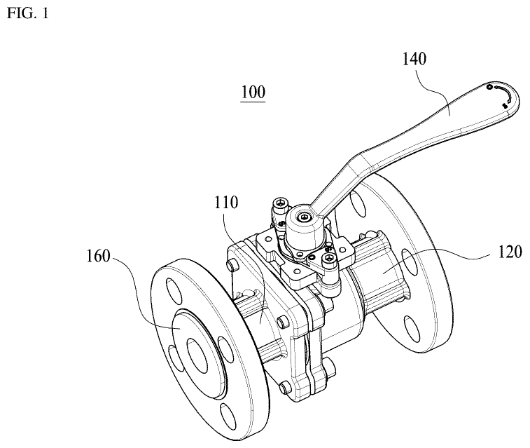

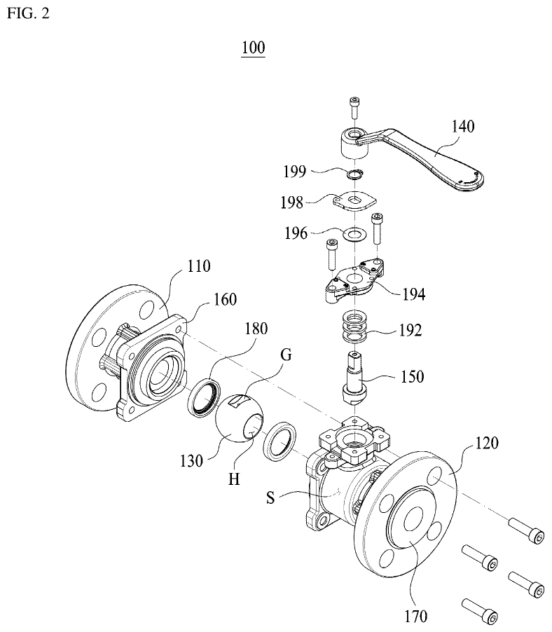

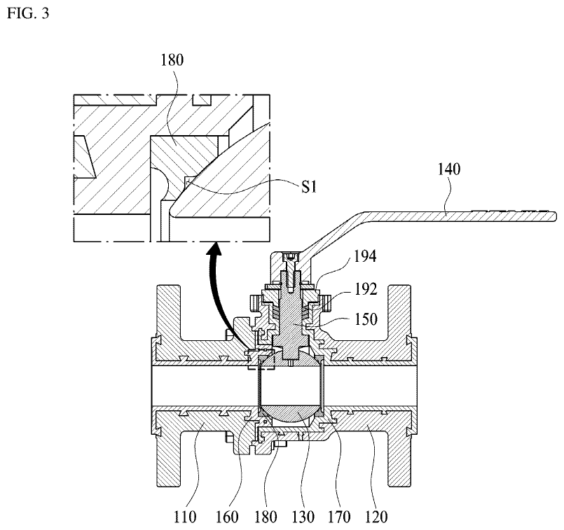

FIG. 1 is a coupling perspective view illustrating a ball valve with an antistatic function according to the present disclosure, FIG. 2 is an exploded perspective view illustrating the ball valve with an antistatic function according to the present disclosure, and FIG. 3 is a cross-sectional view illustrating a ball valve with an antistatic function according to the present disclosure.

Referring to FIGS. 1 to 3, a ball valve 100 with an antistatic function (hereinafter referred to as “ball valve 100”) according to the present disclosure is a valve used to control the flow of a fluid, and the fluid may be various liquid chemicals used in the manufacturing process of semiconductors, displays, etc.

The ball valve 100 may include a cap unit 110, a body unit 120, a ball unit 130, a handle unit 140, a stem unit 150, a first lined unit 160, a second lined unit 170, etc.

The cap unit 110 and the body unit 120 may be coupled to each other using a stud bolt, a nut, and the like and may provide a flow passage of a fluid.

The body unit 120 may provide a space S for accommodating the ball unit 130 alone therein, but the space S may also be provided by coupling between the cap unit 110 and the body unit 120 after the cap unit 110 and the body unit 120 are manufactured to be symmetrical to each other.

The ball unit 130 may be provided on the flow passage of the fluid to control a flow of the fluid by rotation, and a fluid hole H provided to pass through the ball unit 130 may be formed in the center of the ball unit 130.

The handle unit 140 may be a unit for providing an external force for the rotation of the ball unit 130, and the stem unit 150 may be a unit for connecting the ball unit 130 and the handle unit 140 to transmit the external force provided by the handle unit 140 to the ball unit 130.

The ball unit 130 may include an insertion groove G into which a tip of the stem unit 150 is inserted to allow the ball unit 130 to rotate in conjunction with rotation of the stem unit 150.

The first lined unit 160 is a unit provided on an inner surface of the cap unit 110 to prevent the cap unit 110 from coming into contact with the fluid and prevent oxidation of the cap unit 110 due to the fluid, and may be made of perfluoroalkoxy (PFA), which is one type of fluororesin, to increase corrosion resistance.

The first lined unit 160 may be formed on the inner surface of the cap unit 110 at a predetermined thickness by PFA being filled and then cured in a dovetail-shaped groove, which is formed in one surface of the cap unit 110, to increase a coupling force with the cap unit 110.

The second lined unit 170 is a unit provided on an inner surface of the body unit 120 to prevent the body unit 120 from coming into contact with the fluid and prevent oxidation of the body unit 120 due to the fluid, and may be made of PFA, which is one type of fluororesin, to increase corrosion resistance like the first lined unit 160.

The second lined unit 170 may be formed on the inner surface of the body unit 120 at a predetermined thickness by PFA being filled and then cured in a dovetail-shaped groove, which is formed in one surface of the body unit 120, to increase a coupling force with the body unit 120.

The first lined unit 160 and the second lined unit 170 come into direct contact with the fluid and thus can prevent generation of impurities due to the cap unit 110 and the body unit 120 and ensure purity of the fluid.

In addition, the first lined unit 160 and the second lined unit 170 can reduce generation of static electricity due to friction generated during the flow of the fluid and thus can significantly reduce the probability of static electricity generation compared to conventional ball valves.

Meanwhile, the ball unit 130 and the stem unit 150 may be made of a material different from the material for manufacturing the first lined unit 160 and the second lined unit 170.

Specifically, the ball unit 130 and the stem unit 150 may be made of metal for grounding of static electricity that may be generated in the flow passage.

In the ball valve 100 according to the present disclosure, although the probability of static electricity generation due to friction with the fluid is significantly low compared to conventional ball valves due to the first lined unit 160 and the second lined unit 170 as described above, this does not mean that static electricity is not generated at all.

For this reason, in the present disclosure, static electricity may be generated although unlikely, and the ball unit 130 and the stem unit 150 are made of metal such as steel casting stainless (SCS) or steel use stainless (SUS) material to serve as media allowing electric charge to flow.

A grounding line unit (not illustrated) may be connected to the stem unit 150, and grounding becomes possible due to the grounding line unit.

Meanwhile, the ball valve 100 according to the present disclosure may include a seat ring unit 180 provided between the ball unit 130 and the first lined unit 160 to prevent the fluid from flowing toward the stem unit 150 in a case in which the fluid passes through the fluid hole H of the ball unit 130.

The seat ring unit 180 may also be provided between the ball unit 130 and the second lined unit 170 and may be made of polytetrafluoroethylene (PTFE), which is one type of fluororesin.

The seat ring unit 180 may provide a space S1 due to non-contact between surfaces in contact with the ball unit 130, and the space S1 may serve as a space in which the fluid can reside even when the fluid permeates through one of the surfaces and may minimize the possibility of leakage of the fluid.

The ball valve 100 according to the present disclosure may include a V-ring 192, a gland 194, a gasket 196, an indicator 198, and a snap ring 199.

The V-ring 192 may be made of PTFE, which is one type of fluororesin, and may be a part for packing the stem unit 150.

The gland 194 may be made of SCS or steel casting pressure high-temperature 2 (SCPH2) material and may be coupled to the body unit 120 to prevent detachment of the stem unit 150.

The gasket 196 may be made of PTFE.

The indicator 198 is a part for recognizing the degree of rotation of the stem unit 150 or the ball unit 130 that occurs due to rotation of the handle unit 140 and may be made of a SUS material.

The snap ring 199 may be made of a SUS material and may be inserted into the stem unit 150.

To summarize the above, the first lined unit 160 and the second lined unit 170 are components for preventing generation of impurities due to oxidation, corrosion, etc., of the cap unit 110 and the body unit 120 and maintaining the purity of the fluid at a high level.

In addition, due to being made of fluororesin, the first lined unit 160 and the second lined unit 170 can minimize generation of static electricity that may be generated during the flow of the fluid.

For the above reasons, preferably, any component that may come into contact with the fluid may be made of fluororesin to, while maintaining high purity of the fluid, minimize generation of static electricity that may cause problems such as explosion. In other words, there is a need for the ball unit 130 and the stem unit 150 to also be lined with fluororesin.

However, it is not possible to 100% prevent the possibility of static electricity generation even when all components coming into contact with the fluid are made of fluororesin, and when static electricity is generated although unlikely, since grounding of static electricity does not occur, static electricity may cause a very serious problem such as explosion.

Accordingly, in the present disclosure, the ball unit 130 and the stem unit 150 are made of metal so that grounding of static electricity is possible, even if the function of maintaining high purity is somewhat reduced and the possibility of static electricity generation is somewhat increased.

Here, even when the ball unit 130 and the stem unit 150 are made of metal that is not lined with fluororesin, since portions of the ball unit 130 and the stem unit 150 that come into contact with the fluid are relatively small compared to the first lined unit 160 and the second lined unit 170, the extent to which the function for maintaining high purity is reduced due to the ball unit 130 and the stem unit 150 not being lined with fluororesin is insignificant, while the addition of the function for grounding of static electricity ensures a remarkable effect of fundamentally blocking the risk of explosion.

Ultimately, the present disclosure has a major technical feature that the inside of the cap unit 110 and the body unit 120 are lined, while the ball unit 130 and the stem unit 150 are not lined, in order to optimally implement two different effects: the effect of maintaining high purity and the effect of grounding static electricity.

According to a ball valve with an antistatic function according to the present disclosure, by preventing contact between an oxidizable part and a flowing fluid and preventing generation of impurities, purity of the flowing fluid can be maintained.

In addition, by making grounding possible even when static electricity is generated due to friction during the flow of a fluid, a risk of explosion due to sparks or the like can be prevented.

Further, by preventing a flowing fluid from flowing toward a stem, the possibility of leakage of the fluid to the outside can be prevented.

Configurations and features of the present disclosure have been described above based on embodiments according to the present disclosure, but the present disclosure is not limited thereto. It should be apparent to those of ordinary skill in the art to which the present disclosure pertains that various changes or modifications may be made within the spirit and scope of the present disclosure, and it should be noted that such changes or modifications also fall within the scope of the appended claims.

What is claimed is:

1. A ball valve with an antistatic function, the ball valve comprising:
a cap unit and a body unit coupled to each other to provide a flow passage of a fluid;
a ball unit provided on the flow passage of the fluid to control a flow of the fluid by rotation;
a handle unit providing an external force for the rotation of the ball unit;
a stem unit connecting the ball unit and the handle unit to transmit the external force provided by the handle unit to the ball unit;
a first lined unit provided on an inner surface of the cap unit to prevent the cap unit from coming into contact with the fluid and prevent oxidation of the cap unit due to the fluid; and
a second lined unit provided on an inner surface of the body unit to prevent the body unit from coming into contact with the fluid and prevent oxidation of the body unit due to the fluid,
wherein the first lined unit and the second lined unit are made of fluororesin to reduce generation of static electricity due to friction with the fluid, and
the ball unit and the stem unit are made of metal for grounding of the static electricity generated in the flow passage.

2. The ball valve of claim 1, further comprising a grounding line unit connected to the stem unit to make the grounding possible.

3. The ball valve of claim 1, further comprising a seat ring unit provided between the ball unit and the first lined unit to prevent the fluid from flowing toward the stem unit in a case in which the fluid passes through a fluid hole of the ball unit,
wherein the seat ring unit provides a space due to non-contact between surfaces in contact with the ball unit to allow the fluid to reside in the space even when the fluid permeates through one of the surfaces.
